(19) United States
(12) Patent Application Publication
(10) Pub. No.: US 2011/0284573 A1
(43) Pub. Date: Nov. 24, 2011

(54) METHOD OF PROVIDING A TARGET DOSE, POWDER PROVIDER DEVICE AND ITS USE

(76) Inventor: Allan Dagsland, Lund (SE)

(21) Appl. No.: 13/140,079

(22) PCT Filed: Dec. 16, 2009
(86) PCT No.: PCT/SE09/51429

§ 371 Date: Aug. 9, 2011

Related U.S. Application Data
(60) Provisional application No. 61/138,166, filed on Dec. 17, 2008.

(51) Int. Cl. G01F 11/10; B65B 1/04

(52) U.S. Cl. 222/1; 141/2; 222/71

(57) ABSTRACT

The disclosure relates to a method of providing in a powder provider device a target dose of an active pharmaceutical ingredient present in a powder preparation. The active ingredient in a powder sample is analyzed and a powder volume corresponding to the target dose is calculated. The positions of wall portions forming a hole are adjusted relative to each other for receiving the calculated powder volume in the hole. The disclosure also relates to a method of providing a target volume of powder, a powder provider device and a use of a powder dosing system.

This is a U.S. National Phase Application of PCT/SE2009/051429, filed on Dec. 16, 2009, which claims the benefit of priority to U.S. Provisional Application No. 61/138,166, filed on Dec. 17, 2008, all of which are incorporated herein by reference.

### TECHNICAL FIELD

The present invention relates to a method of providing in a powder provider device a target dose of an active pharmaceutical ingredient present in a powder preparation. The invention also relates to a method of providing a target volume of powder, a powder provider device and a use of a powder dosing system.

### BACKGROUND ART

Supply and distribution of medicament is accomplished in many different ways. Within health care more and more effort is focused on the possibility to dose and distribute medicaments in the form of powder directly to the lungs of a user by means of a dispensing device, for example an inhalation device, to obtain an efficient and user-friendly administration of the specific medicament. In some cases, some form of dosing process is used for preparing the dose to be inhaled. The doses of medicament may be provided in is one or more compartments, such as capsules or cavities etc. In some cases the doses of medicament are provided in packs having several cavities for housing a dose of medicament. The cavities filled with a dose are subsequently sealed by a sealing sheet, for example a foil of aluminum. These packs are loaded into a dispensing device, in which the foil above the cavity may be penetrated and the dose of medicament released for inhalation by the user. By this sealing, the medicament is protected before inhalation.

There are also other cases where it is suitable to provide doses of medicament in packs having cavities for housing a dose of medicament, which cavities are sealed by a foil. The packs containing the doses of medicament may be in the form of blister packs or injection molded discs provided with blisters and cavities, respectively, for housing the powdered medicament. The packs can have various shapes, and the cavities can be distributed in various patterns.

International patent application No. PCT/SE2008/050945 in the name of ASTRAZENECA AB discloses a powder provider device which comprises a powder hopper for pouring powder to a dosing system, the disclosure of which is hereby incorporated by reference. The dosing system comprises a hole structure, wherein at least one hole is formed by a surrounding wall structure. The wall structure comprises slidable dosing elements that are movable relative to one another. The entire hole is filled with powder. In order to facilitate the filling of powder into the hole and emptying of powder from the hole, the dosing elements are moved (during said filling and/or emptying) relative to one another.

### SUMMARY OF THE INVENTION

The present invention is based on the insight that, in a dosing system comprising a hole defined by wall portions, it is possible to select different target doses or different target volumes of powder for said hole by adjusting the positions of the wall portions before powder is poured into the hole. The invention is also based on the insight that variations in amount of active pharmaceutical ingredient in a powder preparation in different bulks may be compensated for by adjusting the positions of said wall portions in order to obtain a desired volume of powder. Similarly, variations in powder density in is different bulks of powder may be compensated for by adjusting the positions of said wall portions in order to obtain a desired volume of powder.

According to a first aspect of the invention, there is presented a method of providing in a powder provider device a target dose of an active pharmaceutical ingredient present in a powder preparation. The powder provider device comprises a hole structure, having at least one hole formed by a surrounding wall structure comprising wall portions. The method comprises the steps of:
taking a powder sample from a bulk of powder,
measuring the content of the active pharmaceutical ingredient in said powder sample or the density of said powder sample,
calculating, based on said measuring step, the powder volume corresponding to said target dose,
adjusting the positions of said wall portions relative to each other for receiving the calculated powder volume in the hole, and
providing from said bulk of powder said calculated powder volume into the hole.

By packing as much powder into the hole as possible (without compressing it, or with a predetermined known pressure applied to it), the volume of the powder in the hole is determined by the geometry of the hole. The powder is preferably transferred to the hole and then a scraper passed over the top of the hole to ensure a precise fill.

Thus, this aspect of the invention takes into account a manufacturing process capable of handling batch to batch variations in the content of the active pharmaceutical ingredient. A batch of powder may comprise a different amount of active pharmaceutical ingredient compared to that in another batch of powder. If that is the case, in order to provide the same target dose from different batches, one should not simply take a specific volume of powder for each dose, as that will result in dose variations. Instead, according to this aspect of the invention, the powder volume is adjusted to compensate for the variations between the batches. Similarly, if the powder preparation is 100% pure active pharmaceutical ingredient, the density of the powder may vary from batch to batch. Such variation may also be compensated for by adjusting the powder volume to obtain the is desired weight of pharmaceutical active ingredient in each dose, i.e. to obtain a target dose (desired dose).

When one or more wall portions are in a displaced position and due to the angle of repose of the powder, the powder which falls into the hole will not necessarily fill up the entire available fluid (air) volume in the hole. In other words, when powder falls into the hole, some partial volumes of the hole may be concealed by the displaced wall portions. Thus, the practically available volume for the powder may in some cases be smaller than the fluid volume in the hole.

The wall portions may be formed in a variety of alternative configurations. For instance, the wall portions may be provided by a deformable wall structure made of elastic material. An inside of the elastic material configuration will thus define the hole. The elastic material may be deformed at different portions and to different extents, e.g. by means of poking elements provided on the outside of the elastic material in order to provide for a target volume of powder. Another alternative configuration for changing the available volume may include concentric wall portions telescoping relative to each other, wherein a larger volume is available in an extended (telescoped) state than in a retracted state of the wall portions.

According to at least one example embodiment, said at least one hole comprises a plurality of hole sections defined by respective movable dosing elements of said wall structure, wherein said adjusting step comprises displacing at least one of said dosing elements relative to the others. The dosing elements may suitably be in the form of adjacently located slices or discs with a narrow fit in relation to the size of the powder particles, and may suitably be located on top of each other. Suitably, the slidable dosing elements are made of a ceramic and/or metal-containing material. The number of slidable dosing elements present in the device may be chosen based upon parameters such as the acceptable error margin, maximum volume, practical handling and/or size of the powder particles. For instance, a large number of dosing elements, e.g. 20, enables a larger number of positioning settings, i.e. higher accuracy in setting the target volume, than if a low number of dosing elements, e.g. 2, are used. It should also be noted that the entire hole is does not have to be formed by the hole sections of the dosing elements. For instance, an upper wall portion around the hole may be formed by one type of structure while a lower portion may be formed by the dosing elements. Likewise, an upper wall portion may be formed by similar structure as the dosing elements, however, said similar structures being thicker than the lower dosing elements which are adjusted to provide the target volume.

According to at least one example embodiment, the method comprises displacing said at least one dosing element so that its respective hole section is only partly overlapped by the hole sections of the other dosing elements. Thus, one or more hole sections will be partly offset, i.e. only partly in register with the other hole sections. If more than one dosing element is to be displaced, then they may be displaced in the same direction relative to each other, or they may be displaced in different (e.g. opposite) directions relative to each other.

According to at least one example embodiment, the positions into which said at least one dosing element is displaceable is continuously variable, thereby providing a large freedom of choice for setting the target volume. Thus, although the dosing element may have defined end positions, there are no fixed positions in-between. The setting of the positions of the dosing elements may be varied manually or electronically, e.g. by means of a control unit, such as a computer, operating one or more motors connected to the dosing elements.

According to at least one example embodiment, the positions into which said at least one dosing element is displaceable are discrete positions. This provides a series of different available target volumes, which may be readily set. The setting of positions may be performed manually or electronically, whereby either a single dosing element or a number of dosing elements are adjusted to discrete positions. To set a certain target volume, it may be enough to move a single dosing element, which has a number of different positions into which it may be displaced, to one of said positions. If another target volume is desired, the dosing element is moved to another position. Alternatively, two or more dosing elements may be moved to respective specific positions to set a target volume. Another way is for each dosing element to have a first normal (in-register) position and a second displaced (out-of-register) position, wherein the target volume is set by moving one is or more of said dosing elements all the way from said first position to said second position.

According to at least one example embodiment, the total available fluid volume in the hole is substantially unchanged after said adjusting step, wherein said adjusting step is further based on the angle of repose or the Hausner Ratio of the powder. For instance, if a hole section is partly overlapping other hole sections, the total available fluid volume in the hole may remain substantially unchanged. However, since different types of powder have different angles of repose and, therefore, when poured into the hole, they will take up the available volume to different extent. For instance, a first powder may have an angle of repose of 33°, while a second powder may have an angle of repose of 25°. Thus, for the same available fluid volume, the second powder may take up more of the available volume than the first powder. In other words the powder volume in the hole may be larger (depending on the relative positions of the hole sections) for the second powder than for the first powder. An alternative to a direct calculation of the angle of repose, may be an indirect calculation. The Hausner Ratio or a modified Hausner Ratio has a substantially linear correlation to the angle of repose, which is discussed in the following article: K. Thalberg et al., Comparison of different flowability tests for powders for inhalation, Powder Technology 146 (2004) 206-213. In the article a modified Hausner Ratio was calculated as the ratio between the Compressed Bulk Density of a powder and the Poured Bulk Density of that powder. The article also presents angles of repose for different compositions, which in varying proportions comprised micronized lactose (to simulate an active micronized drug), a carrier lactose (Pharmatose® 325M) and intermediate lactose (Pharmatose® 450M). The different compositions contained in varying amounts 0-10% w/w micronized lactose. The angle of repose for the different compositions varied between about 40°-50°.

According to at least one example embodiment, said at least one dosing element is displaced so that its respective hole section is out of register with the hole sections of the other dosing elements. In other words, for dosing elements arranged on top of each other, the depth of the hole, and consequently the volume of the hole, may be varied by choosing which of the dosing elements is displaced so that its hole section becomes out of register from the other hole sections. The area surrounding the hole section of the displaced dosing is element will now form another bottom level for the hole.

According to at least one example embodiment, the total available fluid volume in the hole is changed after said adjusting step. In the case of using dosing elements having wall portions defining hole sections, the above mentioned displacement of a hole section out of register from the other hole sections (without any overlapping) accomplishes a change in total available fluid volume. If the wall portions comprise an elastic material, some portions of the elastic material may be deformed to change the total available fluid volume. Further, concentric wall portions telescoping relative to each other may also be moved relative to each other in order to change the total available fluid volume.

According to at least one example embodiment, if at least one dosing element is used, the displacing step comprises moving the dosing element substantially perpendicularly to the propagation of the hole. The propagation direction of the hole is herein regarded as the direction extending between an upper opening of the hole and a closed bottom of the hole, i.e. the depth-direction of the hole. The perpendicular displacement may e.g. be a rotational movement or a linear movement.

According to at least one example embodiment, said wall portions comprises lower wall portions and upper wall portions, wherein said adjusting step comprises moving one or more of the lower wall portions. If stacked dosing elements are used, such as in the form of slice-shaped elements, one or more of the lower dosing elements are moved. After the movement of the lower wall portions, i.e. after adjustment of the target volume, powder may be provided into the hole. Next, if desired, the upper wall portions may be moved back and forth to distribute the powder in the hole, and then if more powder is required to reach the target volume, then the upper wall portions are set to their starting position and more powder is introduced into the hole.

According to at least one example embodiment, the method further comprises weighing the powder provided in the hole. This provides an extra check that the target volume of powder has been provided into the hole.

According to a second aspect of the invention, there is presented a method of providing a target volume of powder, comprising
providing a powder provider device comprising a hole structure, having at least one hole formed by a surrounding wall structure comprising wall portions that are movable relative to each other,
adjusting said wall portions relative to each other for receiving said target volume in the hole, and
providing said target volume into the hole.

It should be understood that the second aspect of the invention encompasses any embodiments or any features described in connection with the first aspect of the invention as long as those embodiments or features are compatible with the method of the second aspect.

According to a third aspect of the invention, there is presented a powder provider device, comprising

a powder hopper for pouring powder to a dosing system that comprises a hole structure, wherein at least one hole is formed by a surrounding wall structure, wherein said wall structure is formed by wall portions comprising slidable dosing elements that are movable relative to one another, the device further comprising a user interface having a series of discrete dosing element positioning settings for adjusting the positions of one or more dosing elements in order to receive a target volume of powder in the hole.

The user interface and its function may be implemented in various ways. For instance, the user interface may interact through electronic and/or mechanical means. The user interface may be in the form of a control unit, such as a computer, which is operatively connected to one or more motors for adjusting the positions of the dosing elements. Alternatively, the user interface may be comprise a manual mechanism, such as movable components, for instance rotatable knobs or wheels having distinct positions or markings.

Each dosing element may have a defined number of settings. For instance, a dosing element may be fully in register with the other dosing elements or be displaced to an end position relative to the other dosing elements. There may also be a number of selectable positions therebetween. Thus, a user selection may, for instance, be to move a first and second dosing element to a displaced end position to avoid receiving powder therein, while is maintaining the other dosing elements in a powder receiving position. Another user selection may be to move a first dosing element partly out of register, e.g. 50% in order to allow some powder to be received by the first dosing element, and to move second dosing element(s) the same or another distance, e.g. to allow some other amount of powder to be received in the second dosing element(s), etc. It should be understood that the above is only given as explanatory examples and that there are numerous conceivable variations of the positions of one or more dosing elements.

According to at least one example embodiment, said series of discrete dosing element positioning settings correspond to a number of different distances of displacement of said one or more dosing elements substantially perpendicularly to the propagation of the hole.

The displacement may be a linear displacement or a curved, such as rotational, displacement. The dosing elements per se may be provided with indicia, markings or division into degrees which are associated with positioning settings, or the user interface may be provided with corresponding positioning setting selections.

According to at least one example embodiment, said series of discrete dosing element positioning settings correspond to different degrees or rotation of said one or more dosing elements substantially perpendicularly to the propagation of the hole. If the dosing elements form more than one hole, i.e. a plurality of holes, those holes may suitably be arranged in a generally circular pattern in the circumferential direction of the dosing elements.

According to at least one example embodiment, said at least one hole comprises a plurality of hole sections defined by respective movable dosing elements, a number of said dosing elements being displaceable to a shut position in which their respective hole section is out of register with the hole sections of the other dosing elements, wherein said series of discrete dosing element positioning settings correspond to displacement of one or more of said dosing elements to its respective shut position.

It should be understood that the third aspect of the invention encompasses any embodiments or any features described in connection with the first and/or second aspects is of the invention as long as those embodiments or features are compatible with the powder provider device of the third aspect.

According to a fourth aspect of the invention, there is presented a use of a powder dosing system, which comprises a hole formed by a surrounding wall structure comprising slidable dosing elements that are movable relative to one another, for adjusting a target volume by adjusting the position of one or more of said dosing elements before powder is provided into the hole.

For dosing elements arranged on top of each other, thus forming at least one vertically extending hole, there may suitably be some kind of closing arrangement (e.g. a plate, valve, etc.) underneath the hole which at least initially defines the bottom of the hole.

It should be understood that the fourth aspect of the invention encompasses any embodiments or any features described in connection with the first, second and/or third aspects of the invention as long as those embodiments or features are compatible with the use according to the fourth aspect.

### BRIEF DESCRIPTION OF DRAWINGS

FIG. 1 illustrates a powder provider device according to at least one example embodiment of the invention.

FIG. 2 illustrates in an exploded view details of a powder provider device according to at least one example embodiment of the invention.

FIGS. 3a-3d illustrate some examples of adjusting, before powder is introduced into the hole, hole-defining wall portions relative to each other.

FIGS. 4a-4c illustrate some other examples of adjusting hole-defining wall portions relative to each other.

FIG. 5 illustrates at least one example embodiment of a method according to the present invention.

FIG. 6 shows schematically in plan view an alternative arrangement for driving the hole-defining wall portions.

### DETAILED DESCRIPTION OF DRAWINGS

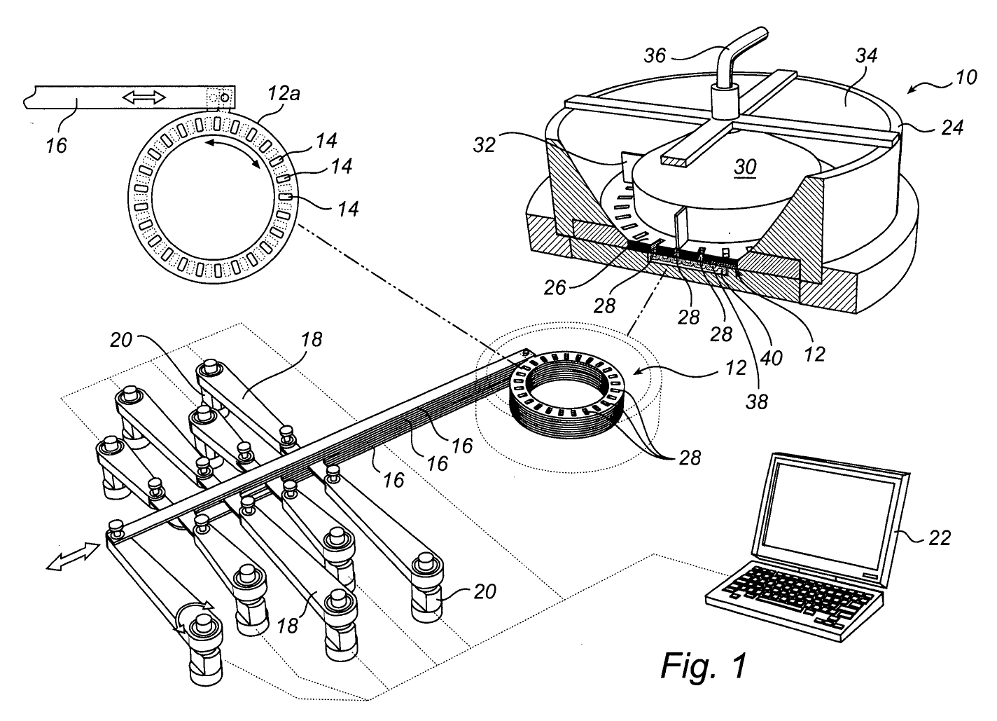

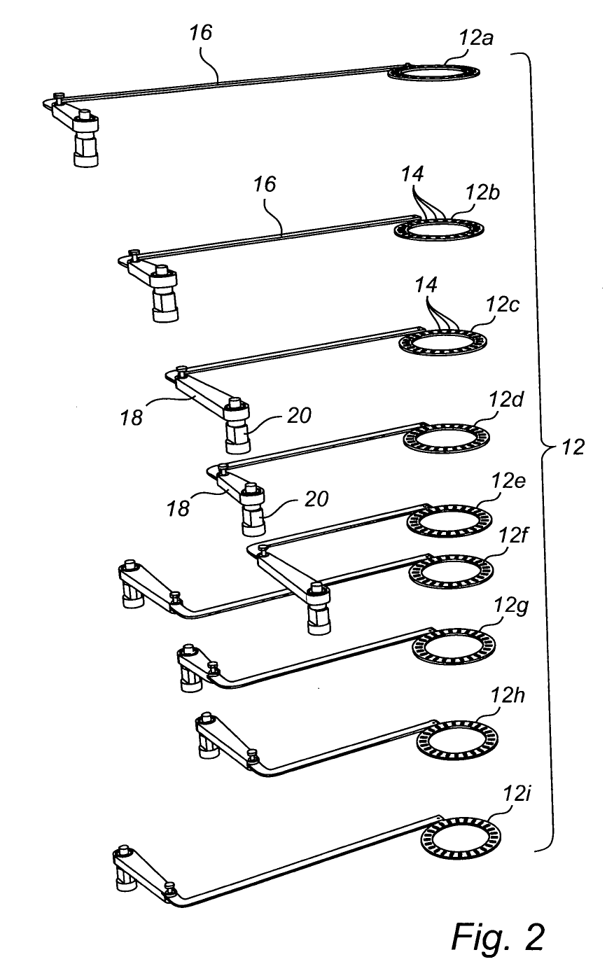

In accordance with at least one example embodiment of the invention, FIG. 1 illustrates a powder provider device 10 and FIG. 2 illustrates in an exploded view details of the powder provider device. More particularly, in FIG. 2, a plurality of dosing elements 12a-12i of a dosing system 12 are illustrated. Each dosing element 12a-12i has the shape of an annular disc having a plurality of through-holes 14 (herein also referred to as hole sections) distributed along the circumference of the dosing element. Each dosing element 12a-12i has, at its periphery, a respective control arm 16 connected. The control arms 16 are, via linking arms 18, coupled to a respective electric motor 20. As illustrated in FIG. 1, the electric motors 20 are operatively connected to and controllable by a control unit, such as a computer 22, the operation of which will be described in a subsequent paragraph.

As illustrated in FIG. 1, the powder provider device 10 comprises a powder hopper 24 for housing powdered medicament (not shown). The powder hopper 24 has a funnel-shaped interior and the sloping surfaces thereof are intended to guide the powdered medicament (not shown) towards the dosing system 12. The dosing system 12 is formed as a hole structure 26 with holes 28 distributed in a circular pattern. More particularly, as previously described, the dosing system 12 comprises individual dosing elements 12a-12i, wherein each dosing element has a plurality of hole sections 14 which together with the hole sections 14 of the other dosing elements form the full holes 28 of the hole structure 26. In the middle of the circular pattern of holes 28 a scraper arrangement 30 is rotatably arranged. The upper side of the dosing system 12 can also be seen as forming the bottom of the powder hopper 24. Scraper blades 32 are arranged to said scraper arrangement 30. When the scraper arrangement 30 rotates the scraper blades 32 follow in close relation with the upper side of the dosing system 12. During rotation of the scraper arrangement 30 the scraper blades 32 will shovel powder of the powder funnel 34 into the holes 28 of the hole structure 26. The scraper blades 32 each pass the holes 28 one by one during rotation of the scraper arrangement 30. A driving axis 36 possibly effects the rotation and the scraping will result in the holes 28 being provided with powder, each hole 28 having an evenly distributed top rim of powder.

When holes 28 of the dosing system 12 have been provided with a target volume of is powder, the powder may be discharged from the holes 28 into respective dosage units, herein illustrated in the form of cavities 38 on a circular disc-shaped cavity structure 40. The cavity structure 40 is arranged underneath the lower portion of the dosing system 12. The openings of the cavities 38 are fitted in close relation to the lowermost dosing element 12i of the dosing system 12. The powder discharge from the holes 28 may be influenced by back and forth movement of the hole wall portions leading to an emptying of the holes 28 (as described in the international patent application PCT/SE2008/050945).

The computer 22 functions as a user interface and receives input from a user who intends to adjust a powder target volume for the holes 28 in the dosing system 12 before powder is provided into the holes 28. Thus, a user may input the desired target volume to the computer 22, which then adjusts the dosing elements 12a-12i to the corresponding positions. Suitably, the computer 22 has a database provided with a set of target volumes corresponding to a series of discrete dosing element positioning settings for adjusting the positions of one or more of the dosing elements 12a-12i. Alternatively, the user could for each dosing element 12a-12i enter a specific position. For instance: “lowest dosing element 12i rotated clockwise 1°, second lowest dosing element 12h rotated anticlockwise 0.5°”. Rather than using a computer 22 and electric motors 20, another alternative would be to rotate the dosing elements 12a-12i manually.

When the dosing elements 12a-12i are rotated they are moved substantially perpendicularly to the propagation of the holes 28, i.e. the dosing elements 12a-12i are rotated around a vertical axis. The rotation of each dosing element is accomplished by a linear movement of the respective control arm 16. Thus, the control arm 16 can be advanced and retracted, wherein the connected dosing element 12a-12i is moved clockwise and anticlockwise, respectively.

Although rotation of circular dosing elements have been illustrated, it should be understood, that other embodiments are also conceivable. For instance, the dosing elements may be in the form of linearly extending plates having holes in one or more straight rows, wherein movement of dosing element would be linear rather than rotational.

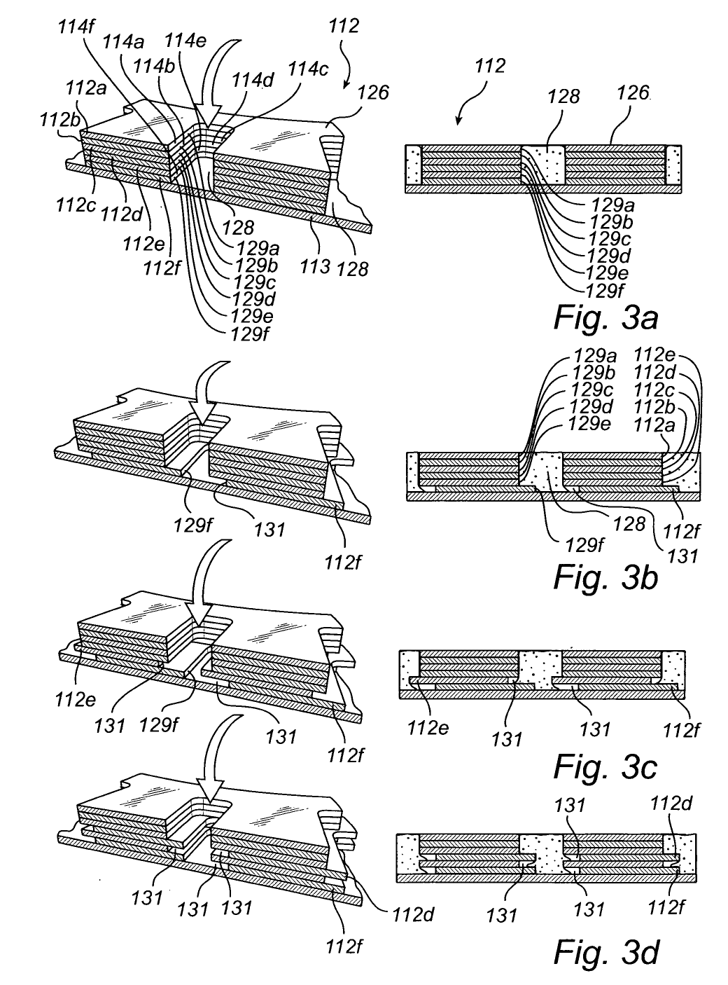

FIGS. 3a-3d illustrate some examples of adjusting, before powder is introduced into the hole, hole-defining wall portions relative to each other. The left hand side of FIGS. 3a-3d illustrate perspective views in cross-section of a hole surrounded by movable wall portions before powder is provided into the hole. The right hand side of FIGS. 3a-3d illustrate cross-sectional views of the hole after powder has been provided into the hole.

Starting with FIG. 3a, a dosing system 112 is illustrated. Similarly, to the dosing system 12 in FIGS. 1 and 2, the present dosing system 112 is in the form of a hole structure 126 with holes 128 distributed in a circular pattern. Furthermore, the dosing system 112 comprises individual dosing elements 112a-112f, wherein each dosing element (e.g. 112a has a plurality of hole sections (e.g. 114a) which together with the hole sections (e.g. 114b-114f) of the other dosing elements form the full holes 128 of the hole structure 126.

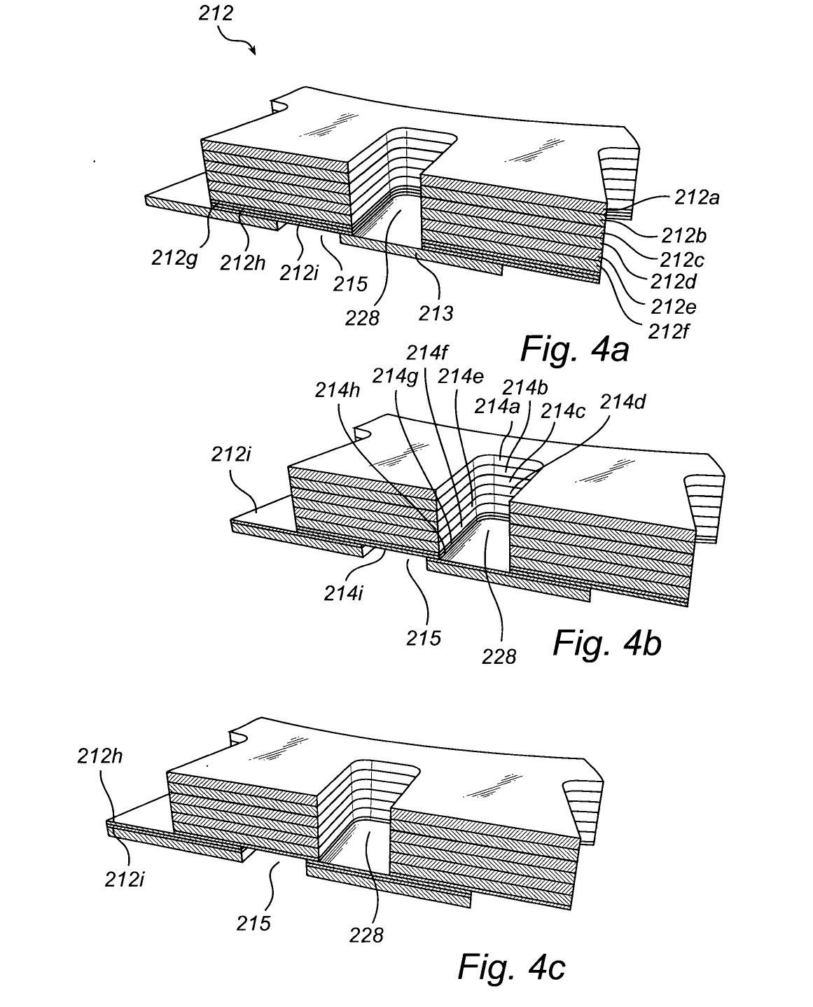

A closing arrangement 113, herein illustrated as a plate, is positionable in a first position so that it will block the holes 128, thereby preventing powder to fall through the holes. The closing arrangement 113 is thus adapted to form a bottom of the holes when in said first portion. When the desired target volume of powder has been provided into the holes 128, a lid arrangement (not shown) is moved to block the holes 128 from above, thereby preventing further powder from entering the holes 128. Thereafter, the hole structure 126 may be turned upside down and after opening the lid arrangement (now being at the bottom) the powder can be emptied from the holes 128 into respective dosage units. Alternatively, rather than turning the hole structure upside down, the lower closing arrangement may be provided with openings 215 (see FIGS. 4a-4c) which can be aligned with the holes 128 in the hole structure 126. Thus, moving the closing arrangement into such alignment enables the powder in the holes 128 to be emptied suitably into respective aligned dosage units (e.g. as arranged in the illustration of FIG. 1). Furthermore, rather than having a specific lid arrangement, the uppermost dosing element 112a may function as a lid arrangement for alternatingly closing the holes 128 and opening the hole 128 for receiving powder. Likewise, rather than having a specific closing arrangement 113, the lowermost dosing element 112f could act as a closing arrangement without needing any other particular features, simply by placing its hole section 114f out of register with the other hole sections 114a-114e, thereby providing a bottom of the holes 128. In the latter case, although having the same structural features as the other dosing elements 112a-112e, the lowermost dosing element 112f would not be regarded as a dosing element in the context of this application.

As can be seen in FIG. 3a, each hole 128 is formed by a surrounding wall structure comprising wall portions 129a-129f. The wall structure is composed of a plurality of slidable dosing elements 112a-112f which are provided as a pile of slices. Each dosing element (e.g. 112f) comprises respective wall portions (e.g. 129f) that define a sliced hole section (e.g. 1140 of the entire hole 128.

In FIG. 3b the target volume has been adjusted compared to that in FIG. 3a. More specifically, in FIG. 3b, the lowermost dosing element 112f has been somewhat displaced, so that its wall portions 129f are no longer aligned with the wall portions 129a-129e of the other dosing elements 112a-112e. Consequently, the lowermost hole section 114f is only partly overlapped by the other hole sections 114a-114e. As a result of this displacement, a compartment 131 is formed underneath the second lowest dosing element 112e. As illustrated in FIG. 3b, when powder is provided into the hole 128, some powder will come into the formed compartment 131. However, due to the angle of repose of the powder, the entire compartment 131 will not be filled with powder, but rather leave an air pocket. Thus, although the available fluid volume in the hole 128 has not changed, the available powder volume has been reduced due to the displacement of the lowermost dosing element 112f.

FIG. 3c illustrates an even smaller powder target volume. Now the two lowermost dosing elements 112e and 112f have been displaced. The very lowest dosing element 112f has been moved towards the right in the figure, while the other displaced dosing element 112e has been moved towards the left in the figure. This time, two compartments 131 have been formed. Although FIG. 3c illustrates two dosing elements 112e and 112f displaced in opposite directions, it should be understood that another alternative is to displace them in the same direction, with the same or with different distance of displacement. Thus, there exists numerous variations for creating a desired target volume, wherein the various suitable locations for the dosing elements may suitably be determined empirically.

FIG. 3d illustrates another situation, in which two dosing elements 112d and 112f have been displaced. This time, the lowermost dosing element 112f and the third lowest is dosing element 112d have both been moved to the right in the figure, thereby forming three compartments 131. Consequently, the available powder volume is smaller than in the situation illustrated in FIG. 3c.

It should be noted that it is not only the number of dosing elements displaced that effect the available powder volume, but also the distance each dosing element is displaced. A longer displacement results in a smaller available powder volume in the hole. For instance, if a dosing element is displaced a distance corresponding to half the hole diameter, a smaller available powder volume is obtained compared to a case where the dosing element is only displaced a quarter of the hole diameter. Rather than making one or more hole sections partly offset with respect to the other hole sections, thereby providing compartments into which some powder is allowed to enter, an alternative is to completely move one or more hole sections out of register with the remaining hole sections. This is illustrated in FIGS. 4a-4c.

Similarly to FIG. 3a, a dosing system 212 having a plurality of dosing elements 212a-212i are illustrated in FIG. 4a. However, in FIG. 4a, the three lowermost dosing elements 212g-212i are considerably thinner than the other dosing elements 212a-212f. In FIG. 4b, the lowermost dosing element 212i has been moved so that its hole section 214i is completely out of register with the hole sections 214a-214h of the other dosing elements 212a-212h, thereby providing a reduced volume. In FIG. 4c, an even smaller volume is obtained by displacing the two lowermost dosing elements 212h and 212i (this would also be obtained by only displacing the second lowest dosing element 212h).

In FIG. 4a the bottom level of the hole 228 is defined by the closing arrangement 213. In FIG. 4b, the bottom level of the hole 228 has been moved up corresponding to the thickness of the lowermost dosing plate 212i. Compared to the initial level shown in FIG. 4a, the bottom level of the hole 228 has in FIG. 4c been even further moved up (corresponding to the thickness of the two lowermost dosing elements 212h and 212i).

Although the use of complete offset hole sections (as illustrated in FIGS. 4b and 4c) does not give the possibility of having as many variations as if only partial offsets are used is (as illustrated in FIGS. 3b-3d), it is easier to determine the available powder volume since it substantially corresponds to the available fluid volume. It should be noted that rather than having three thin dosing elements 212g-212i any other number of thin dosing elements may be used, e.g. all of the dosing elements may be thin. Many thin dosing elements would enable more setting alternatives. The thickness of an individual dosing element may suitably be in the range of 0.2-0.6 mm. The maximum available fluid volume of the total hole may suitably be in the range of 5-25 mm³.

The maximum available fluid volume of the hole may suitably be somewhat over dimensioned to account for deviations from an average content of the active ingredient. Thus, for a batch of powder having the normal average content of the active ingredient, the wall portions would be displaced in a determined manner to enable reception of the desired powder volume. For instance, an average content could correspond to having a determined number of dosing elements completely shut (hole section(s) out of register with remaining hole sections), and thus allowing, from such an average situation, to increase or reduce the available powder volume depending on the active ingredient content deviations from the average content. Thus, if a batch has a higher content of the active ingredient, then the wall portions would be displaced so that the hole will receive a smaller powder volume compared to the average situation. However, if a batch has a lower content of the active ingredient, then the wall portions would be adjusted so that the hole can receive a larger volume compared to the average situation. In the rare case of an exceptionally low content, which would require a powder volume larger than the maximum available fluid volume, an extra dosing element (having a hole section) may be mounted to expand the existing hole. Alternatively, one or more of the existing dosing elements may be replaced by one or more dosing elements having larger hole sections.

The possibility to use partially overlapping hole sections 114a-114f illustrated in FIGS. 3b-3d means that the positions into which the dosing elements 112a-112f are displaceable is continuously variable. The use of complete offsets illustrated in FIGS. 4b and 4c means that the positions into which the dosing elements 212a-212i are displaceable are discrete positions. It should be noted, that discrete positions may also be provided for the alternative illustrated in FIGS. 3b-3d, such as defined distances of movement (e.g. a is quarter of the hole diameter, half of the hole diameter, three quarters of the hole diameter, a full hole diameter movement, etc.).

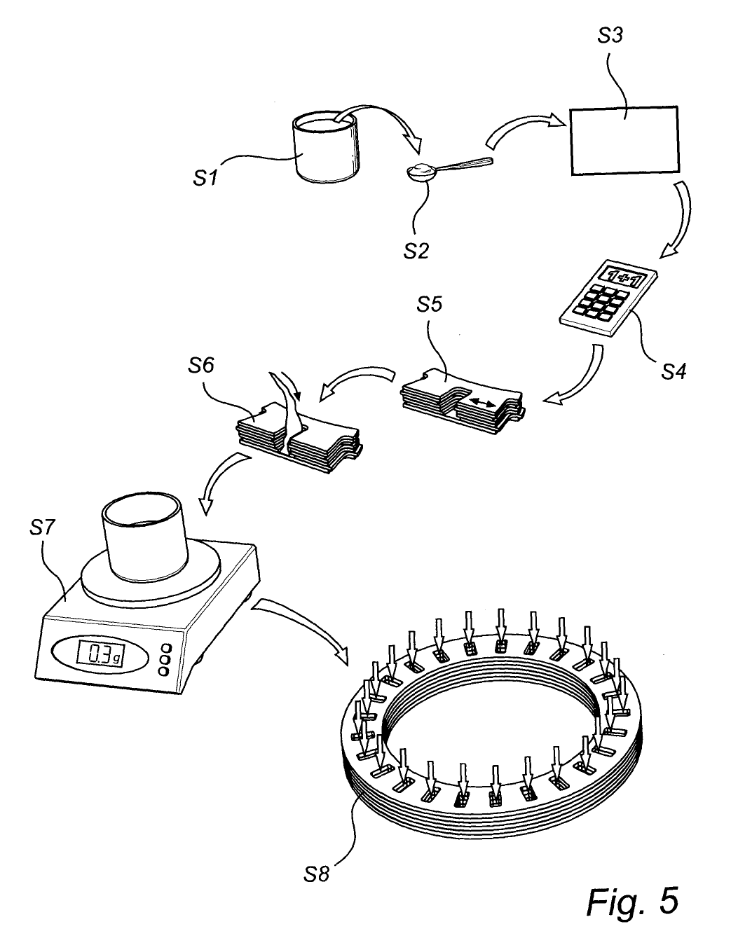

FIG. 5 illustrates at least one example embodiment of a method according to the present invention. In a first step S1, a batch or bulk of powder is provided. The batch of powder is intended to be divided and packed into individual dosage units. Such dosage units may be provided on a common base or pack, such as a dose-cavities containing disc for an inhaler. Alternatively, such dosage units may be separate entities, e.g. capsules.

When a batch of powder is provided, its content (such as percentage of active ingredient or the density) may differ from that of previously or subsequently provided batches. It may also differ from a desired content. The exemplified method allows of uniform manufacturing of dosage units, without any substantial batch-to-batch difference. A dose may generally be prescribed as a certain weight of an active pharmaceutical ingredient. Thus, with the exemplified method, the weight of the active pharmaceutical ingredient will be substantially the same in all manufactured dosage units, irrespective of from which batch they have been produced.

Before providing the powder in the batch into dosage units, a number of steps are carried out. In a second step S2, a sample is taken from the batch of powder.

In a third step S3, the sample content is measured/analysed using any customary chemical or physical analysis. A chemical analysis may, for instance, be performed by means of the well known high-pressure liquid chromatography (HPLC). A physical analysis may, for instance, be performed by means of any well know spectrometric method, such as including those which analyze the response signal of a sample irradiated with near infrared (NIR) radiation. If the powder only consists of active pharmaceutical ingredient, the measuring step S3 may simply be a density measurement, i.e. weight of the sample divided by its volume. However, commonly the desired information to be analyzed is the percentage of weight of the active pharmaceutical ingredient in the sample volume.

In a fourth step S4, based on the measuring in step S3, a target volume for the powder is calculated. In other words, it is calculated which powder volume would correspond to a desired dose of active pharmaceutical ingredient, i.e. a desired weight of is the active pharmaceutical ingredient.

In a fifth step S5, in a dosing system of a powder provider device having holes defined by wall portions, the wall portions are adjusted to receive said target volume of powder, as illustrated by the double-headed arrow. For instance, the adjustment may be performed as exemplified in the previous figures, or in any other suitable manner.

In a sixth step S6, there are at least two alternatives for providing powder. Since all the holes of the dosing system are now adjusted to receive said target volume of powder, one alternative is to pour powder from the batch into all of the holes. The powder can then be transferred to dosage units (e.g. cavity discs, blisters, capsules etc.) for further handling and packaging. Another alternative is to just provide the sample powder into one or more holes before filling all the holes. After the sample powder has been poured into one or more holes, each adjusted to receive a target volume of powder, the poured powder may be check weighed to confirm that indeed the desired volume has been obtained by said adjustment of the hole-defining wall portions. This is illustrated as a seventh step S7. This check-weighing may be suitable to use when the wall portions are adjusted manually or adjusted with control means which are not accurate enough for the particular situation.

If the seventh step S7 confirms that the target volume has indeed been obtained, all the powder from the batch may be provided into the holes of the dosing system of the powder provider device. This is illustrated in an eighth step S8. Thereafter, the powder is transferred to dosage units. From a practical point of view, it may be suitable to take a sample of powder which is large enough to fill all of the holes. The entire dosing system may then be check weighed in step S7. Then, after each emptying of the holes of the dosing system, the holes may repeatedly receive new powder from the batch and transfer it to dosage units, until all the powder has been taken from the batch.

FIG. 1 shows, amongst other things, the drive mechanism for moving the discs/slices 12. Each annular slice 12 is connected via a pin joint to an actuating arm 16 which extends generally tangentially to the respective slice. The arm 16 is angled at the end remote from the slice 12, and connected via a further pin joint to a link 18 which is mounted at its far end to the spindle 20 of an electric motor (not shown). When a particular slice 12 needs to be moved, the motor turns through a few degrees and this is motion is transferred via the link 18 and arm 16 to the slice.

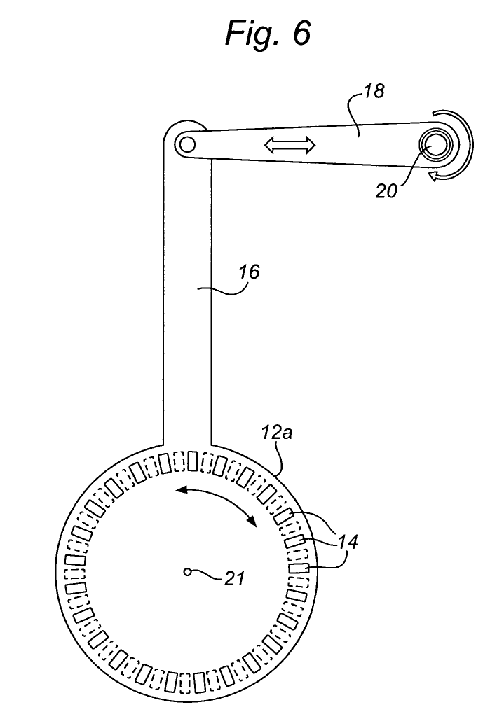

FIG. 6 shows an alternative arrangement in a view corresponding to the plan view at the top left of FIG. 1. Equivalent parts are numbered the same. In this arrangement, each slice is a solid disc, with no central hole. Each arm 16 is integral with a respective disc 12a and projects radially outwardly from it. At the far end of the arm 16, it is joined to a link 18 via a pin joint. The link 18 is, in turn, mounted on an eccentric shaft 20 of an electric motor (not shown). As the motor moves the eccentric shaft around, a linear reciprocating motion is imparted to the link 18 which, in turn, moves the arm 16 and disc 12a by a few degrees about a central pivot point 21. In all other respects this alternative arrangement functions in exactly the same way as the previously described embodiment.

1. A method of providing in a powder provider device a target dose of an active pharmaceutical ingredient present in a powder preparation, wherein the powder provider device includes a hole structure having at least one hole formed by a surrounding wall structure including wall portions, the method comprising:
taking a powder sample from a bulk of powder;
measuring one of the content of the active pharmaceutical ingredient in said powder sample and the density of said powder sample;
calculating, based on said measuring step, a powder volume corresponding to said target dose;
adjusting the positions of said wall portions relative to each other for receiving the calculated powder volume in the at least one hole; and
providing from said bulk of powder said calculated powder volume into the at least one hole.

2. The method of claim 1, wherein said at least one hole comprises a plurality of hole sections defined by respective movable dosing elements of said wall structure, and wherein said adjusting step further comprises displacing at least one of said dosing elements relative to the others.

3. The method of claim 2, further comprising displacing said at least one dosing element so that its respective hole section is only partly overlapped by the hole sections of the other dosing elements.

4. The method of claim 2, wherein the positions into which said at least one dosing element is displaceable are continuously variable.

5. The method of claim 2, wherein the positions into which said at least one dosing element is displaceable are discrete positions.

6. The method of claim 1, wherein a total available fluid volume in the at least one hole is substantially unchanged after said adjusting step, and wherein said adjusting step is further based on one of an angle of repose and a Hausner Ratio of the powder.

7. The method of claim 2, further comprising displacing said at least one dosing element so that its respective hole section is out of register with the hole sections of the other dosing elements.

8. The method of claim 1, wherein a total available fluid volume in the at least one hole is changed after said adjusting step.

9. The method of claim 2, wherein the displacing step includes moving the at least one dosing element substantially perpendicularly to a propagation of the at least one hole.

10. The method of claim 1, wherein said wall portions include lower wall portions and upper wall portions, and wherein said adjusting step includes moving one or more of the lower wall portions.

11. The method of claim 1, further comprising weighing the powder provided in the at least one hole.

12. A method of providing a target volume of powder, comprising:
providing a powder provider device including a hole structure having at least one hole formed by a surrounding wall structure including wall portions that are movable relative to each other, wherein the wall structure includes a series of stacked plates which are independently movable to provide the movable wall portions;
adjusting said wall portions relative to each other for receiving said target volume in the at least one hole; and
providing said target volume into the at least one hole.

13. (canceled)

14. A powder provider device, comprising:
a powder hopper configured to pour powder to a dosing system that includes a hole structure including at least one hole, wherein the at least one hole is formed by a surrounding wall structure, wherein said wall structure includes wall portions including slidable dosing elements that are movable relative to one another; and
a user interface including a series of discrete dosing element positioning settings configured to adjust the positions of one or more dosing elements in order to receive a target volume of powder in the at least one hole.

15. The powder provider device of claim 14, wherein said series of discrete dosing element positioning settings correspond to a number of different distances of displacement of said one or more dosing elements substantially perpendicularly to a propagation of the at least one hole.

16. The powder provider device of claim 15, wherein said series of discrete dosing element positioning settings correspond to different degrees of rotation of said one or more dosing elements substantially perpendicularly to a propagation of the at least one hole.

17. The powder provider device of claim 14, wherein said at least one hole includes a plurality of hole sections defined by respective movable dosing elements, wherein a number of said dosing elements are displaceable to a shut position in which their respective hole sections are out of register with the hole sections of the other dosing elements, and wherein said series of discrete dosing element positioning settings correspond to displacement of one or more of said dosing elements to its respective shut position.

18. A method of using a powder dosing system, the system comprising a hole formed by a surrounding wall structure comprising slidable dosing elements that are movable relative to one another, for adjusting a target volume by adjusting the position of one or more of said dosing elements before powder is provided into the hole.
